(19) United States
(12) Patent Application Publication
(10) Pub. No.: US 2010/0176148 A1
(43) Pub. Date: Jul. 15, 2010

(54) Detergent Dispensing Device

(75) Inventors: Guido BRANDT, Victoria (AU); Thomas Enkel, Ellerstadt (DE); Karl-Ludwig Gibis, Ludwigshafen (DE); Michael Hahl, Bern (CH); Chris Efstathios Housmekerides, Ludwigshafen (DE); Brendyn Rodgers, Victoria (AU)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Reckitt Benckiser N.V., Hoofddorp (NL)

(21) Appl. No.: 12/749,061

(22) Filed: Mar. 29, 2010

Related U.S. Application Data
(62) Division of application No. 11/574,158, filed on Jan. 4, 2008.

(30) Foreign Application Priority Data
Aug. 23, 2004 (GB) 0418760.5
Feb. 22, 2005 (GB) 0503573.8
Apr. 5, 2005 (GB) 0506812.7

(51) Int. Cl. B67D 7/00

(52) U.S. Cl. 222/52

(57) ABSTRACT

A detergent dispensing device for an automatic washing machine, the device having a plurality of chambers to accommodate a detergent composition, a selecting means to selectively expose each chamber to wash liquor allowing the detergent, in use, to be washed out of the chamber; a manual operating means being movable from a first position to a second position for loading mechanical energy into the device which provides a restoring force for the operating means, and a return motion prevention means to retain the operating means in the second position, the return motion prevention means being arranged to move when subjected to a condition prevailing in an interior of the machine during a wash cycle, thereby moving the operating means to the first position or releasing the operating means to return to the first position during a single wash cycle; the operating means being arranged to move the selecting means and cartridge relatively to one another to advance the selecting means to an adjacent chamber as it moves either from the first to the second position, the second to the first position, or both.

The present invention is related to a detergent dispensing device, particularly for dispensing said detergent into an automatic dishwashing or washing machine over a plurality of washing cycles.

In automatic dishwashing machines, the detergent, whether in powder, tablet or gel form, is usually filled manually by the user into the machine, in particular into a detergent holder, before each dishwashing operation.

This filling process is inconvenient, with the problem of exact metering of the detergent and possible spillage thereof, for powder and gel detergents. Even with detergents in tablet form, wherein the problem of accurate dosing is overcome, there is still the necessity of handling the dishwashing detergent every time a dishwashing cycle is started. This is inconvenient because of the usually corrosive nature of dishwasher detergent compositions.

A number of devices are known for holding unit doses of a detergent composition or additive, such as detergent tablets, and for dispensing of such unit doses into a machine.

WO 01/07703 discloses a device for the metered release of a detergent composition or additive into a dishwashing machine having a number of separate sealed chambers for holding the detergent composition or additive and means for piercing the chambers, activated by conditions within the machine.

WO 03/073906 discloses a free standing device for dispensing multiple doses of detergent into a dishwasher. The device has a plate-like construction. A round blister pack having a plurality of doses arranged around its periphery is loaded into the pack. A winder is then rotated to load mechanical energy into the device sufficient to dispense more than one dose of detergent. A thermally operated latch then moves when the device is subjected to the elevated temperatures within the dishwasher and, in cooperation with a ratchet mechanism, moves the blister pack so that the next dose of detergent is ready for dispensing. In order to dispense the detergent, either the blister pack is pierced, or the dose is ejected from its compartment within the blister pack.

WO 03/073907 discloses a similarly shaped free standing dispensing device. In order to dispense detergent, a lever is manually operated to move a blister pack either to eject the detergent from a compartment within the blister pack, or to pierce the blister pack. A door or flap initially prevents wash liquor within the machine from accessing the exposed detergent. A bi-metallic strip is provided to move the door or flap when the device is exposed to the elevated temperatures during a washing cycle to allow access of the wash liquor to the exposed detergent thereby dispensing the detergent to the machine.

WO 01/07703 and WO 03/073906 are both automatic devices in the sense that they are designed to dispense detergent in a number of consecutive washing cycles without any user intervention. WO 03/073906 is a manually operated device in which the user moves a lever to eject the detergent, and the lever is then moved back into position by a return spring. Once returned, there is nothing to prevent the user activating the lever again to dispense a further dose of detergent before the machine has run.

According to the present invention there is provided a detergent dispensing device for an automatic washing machine, the device having a plurality of chambers to accommodate a detergent composition, a selecting means to selectively expose each chamber to wash liquor allowing the detergent, in use, to be washed out of the chamber; a manual operating means being movable from a first position to a second position for loading mechanical energy into the device which provides a restoring force for the operating means, and a return motion prevention means to retain the operating means in the second position, the return motion prevention means being arranged to move when subjected to a condition prevailing in an interior of the machine during a wash cycle, thereby moving the operating means to the first position or releasing the operating means to return to the first position during a single wash cycle; the operating means being arranged to move the selecting means and cartridge relatively to one another to advance the selecting means to an adjacent chamber as it moves either from the first to the second position, the second to the first position, or both.

The device is designed so that it requires manual intervention between each wash cycle. This offers a number of advantages over the fully automatic devices in the prior art. There is no need to provide the complex and relatively large mechanism of WO 03/073906 allowing the device to store energy for a number of cycles. Further, the device can be made more reliable than WO 01/07703 which relies fully on conditions within the machine to provide the energy to move the device to the next dose of detergent. Also, unlike WO 03/073907, there is no danger than an additional detergent dose can be dispensed before a subsequent wash cycle. Once a user has manually operated the device, the operating means is held in place until released during the operating cycle.

The operating means may be arranged to advance the selecting means to an adjacent chamber as it moves from the second to the first position. In this case, when a user operates the operating means, this will simply load mechanical energy into the device and will not move the selecting means. The return motion prevention means will then be designed to operate quickly during the wash cycle to release the operating means to return to the first position thereby advancing the selecting means and exposing the detergent. Alternatively, the return motion prevention means is designed to operate at the end of the wash cycle to expose the detergent for the next cycle.

Preferably, however, the device is configured to operate in the opposite manner so that the operating means is arranged to advance the selecting means to an adjacent chamber as it moves from the first to the second position. When a user operates the operating means, this loads mechanical energy into the device and advances the selecting means. In this case, the return motion prevention means is preferably designed to operate slowly to release the operating means to return to the first position towards the end of a single wash cycle.

It could even be the case that the return motion prevention means is designed to release the operating means as the washing machine cools after the machine has completed washing. For the purposes of this invention, this is considered to be “during a single wash cycle” in as much as this cooling stage is considered to be part of such a wash cycle. The important consideration is that a user must load mechanical energy into the device for each wash cycle, rather than loading energy for multiple cycles as in WO 03/073906.

Some combination of the two types of movement is also envisaged. For example, a chamber may contain two different types of detergent, the first of which is exposed as the selecting means moves from the first to the second position, and the second of which is exposed as the operating means moves in the opposite direction.

The condition prevailing in an interior of the machine may, for example, be a condition such as wash liquor flow. The device may be designed to collect a certain mass of wash liquor which, once it reaches a predetermined threshold, moves the latching means. Alternatively, the condition may be pH or water conductivity. However, preferably, the return motion prevention means is a thermal element arranged to be moved when subjected to a predetermined temperature. The thermal element may be a memory metal/memory alloy, thermal bimetal, bimetal snap element, shape memory polymer or wax motor. The predetermined temperature is preferably between 25° C. and 55° C. (more preferably 38° C. to 40° C.). The return motion prevention means may be a latch which selectively obstructs return motion of the operating means. Alternatively, it may be a thermally expandable element which is moved on operation of the operating means, but will not return to its original position until subjected to an elevated temperature when it expands to move the operating means.

The thermal element preferably has a historisis effect. This delays the operation of the thermal element to ensure that the device is not reset during the early part of the wash cycle of the machine, but is only reset once the machine has carried out the full washing process.

This can be achieved in a number of different ways.

The first with a thermal element may be designed such that it has a hysteresis (time and/or temperature based). Thus the thermal element is activated at the start of the wash cycle. However, (for a temperature hysteresis effect) the thermal element is designed such that the decreasing temperature between the wash cycle(s) and the rinse cycle(s) is not sufficient to de-activate the element, and so re-activation at the start of the rinse cycle cannot occur. In this case the thermal element preferably has an activation temperature of around 38° C. to 45° C. and a de-activation temperature of around 25° C. to 33° C.

For a time hysteresis effect the thermal element is designed such that it can only be activated once during a dishwasher cycle. Typically from 30 minutes to 2 hours.

A simulated temperature hysteresis effect may be achieved by providing a jacket around the thermal element. The jacket is intended to fill with hot wash liquor from the wash cycle. The jacket preferably has a small outlet aperture. The small outlet aperture means that during the relatively cool period between the wash and rinse cycle(s) the jacket retains the majority of the hot wash liquor, meaning that the thermal element is not de-activated during this cooler period.

A further hysteresis effect may be achieved mechanically. In this case, by use of, for example, a double ratchet mechanism, the thermal element is allowed to react to both of the temperature changes. However, a double ratchet mechanism means that only the first activation cycle causes a change to the opening of a chamber of the device; the second activation is nullified by the second ratchet.

For the wax motor the melting and solidification behaviour of the wax itself can be used for the hysteresis, because certain wax types show slow solidification compared to melting.

Also for the wax motor the hysteresis effect may be achieved by an water collector (having a small/slow water release aperture) which prevents the wax motor from the second movement by the weight of the collected water. The water collector preferably empties over 20 minutes to an hour.

If the chambers contain both wash detergent and rinse aid with both being intended to be released in to their respective cycle(s) the activation of the thermal element at both cycle(s) is advantageous.

Generally the automated component includes a reset mechanism to cover the eventuality that a consumer disrupts the operation of the automatic washing machine during a washing cycle.

The selecting means may be any means by which the detergent in an adjacent chamber can be selected. For example, it may be a mechanism for ejecting the detergent, or it may be a mechanism for piercing or peeling a film seal in a compartment.

The selecting means may be any mechanism for selectively exposing a chamber to the wash liquor within the machine. Preferably, however, the selecting means has an opening which is selectively alignable with each chamber. For example, the selecting means may comprise a film comprising an opening which is moved linearly or rotatably into alignment with a chamber. However, preferably, the selecting means comprises a spout which is rotatable into alignment with an opening to a respective chamber. This spout is preferably designed to block access of the wash liquor to unselected chambers.

Preferably, the device is provided with a funnel leading to the selecting means. This increases the amount of wash liquor which can be directed into a selected chamber.

The selecting means may either be configured to be operated by the hand of a user, or may be configured to be operated by the door of the machine.

The present invention also extends to a method for dispensing detergent into an automatic washing machine from a device having a plurality of chambers to accommodate a detergent composition, the method comprising manually moving an operating means before each wash cycle from a first position to a second position for loading mechanical energy into the device to provide a restoring force for the operating means, initially retaining the operating means in the second position, subjecting the device to a wash cycle, allowing the operating means to return to the first position during the wash cycle when subjected to a condition prevailing in an interior of the machine during a wash cycle, wherein the operating means advances a selecting means to an adjacent chamber as it moves either from the first to the second position, the second to the first position, or both.

The device is preferably for use in an automatic dishwasher. Accordingly the detergent most preferably comprises an automatic dishwasher detergent. Examples of which include conventional detergents, and the ‘2-in-1’ and ‘3-in-1’ variants. Most preferably the detergent comprises a solid. In the context of the present invention the term solid can be taken to include solidified gels as well as conventional solid materials (such as compressed particulate materials and solidify molten/cross linked materials).

The detergent formulation typically comprises one or more of the following components; builder, co-builder, surfactant, bleach, bleach activator, bleach catalyst, enzyme, polymer, dye, pigment, fragrance, water and organic solvent.

Optionally the detergent comprises a detergent additive. It will be appreciated that a detergent additive when compared to a detergent may be required during a different section of the dishwasher wash cycle (e.g. such as the rinse cycle for a rinse aid detergent additive).

Indeed successive chambers of the cartridge may be filled with different detergent compositions. For example a first chamber, intended to be dispensed in a wash cycle of a dishwasher may contain a ‘wash formulation’ and a second chamber, which may for convenience be located adjacent to the first chamber, may contain a rinse aid formulation for dispensing in a rinse cycle of an automatic dishwasher.

The chamber may be divided into sub-chambers, each of them being exposed to the washing liquor at once, to ensure stability of incompatible ingredients of the detergent (i.e. enzymes and bleach).

It will be appreciated that in the scenario as described in the preceding paragraph the first and second chambers may be sized differently to suit their different purposes.

The detergent may be added to the cartridge by any suitable method. The detergent may be added to the cartridge manually, by casting or by injection moulding.

A suitable injection moulding process is described in British Patent Application No 0323659.3 and British Patent Application No 0415786.3.

Preferably the device includes an indication mechanism to show how many chambers of the cartridge remain (i.e. are still full of detergent) so that a user has an idea of when a replacement is required. A preferred form of an indication mechanism comprises a marking on the cartridge which can be viewed by a consumer. The marking may comprises a series of numerals arranged in association with one or more of the chambers of the cartridge. Such a marking may require a window in order to be viewed by a consumer. Optionally the marking may be associated with a fixed marker so that the relevant part of the marking is clearly indicated.

Optionally the marking may employ a colour scheme (e.g. along the lines of a traffic light system with red meaning that only a small number of chambers remain, yellow an intermediate number and green a large number of chambers remain.

Generally the device includes an “end-of-life” indicator to show when the cartridge has been used. Normally the “end-of-life” indicator provides two functions: firstly it high-lights to the consumer that the cartridge needs replacing and secondly it prevents further activation of the cartridge.

The “end-of-life” indicator may be a part of the indication mechanism (as discussed above). Alternatively it may comprise a separate indicator.

Usually the “end-of-life” indicator is deactivated when a new/replacement cartridge is added to the device. The deactivation may be automatic or require manual input.

Examples of the present invention will now be described with reference to the accompanying drawings, in which:

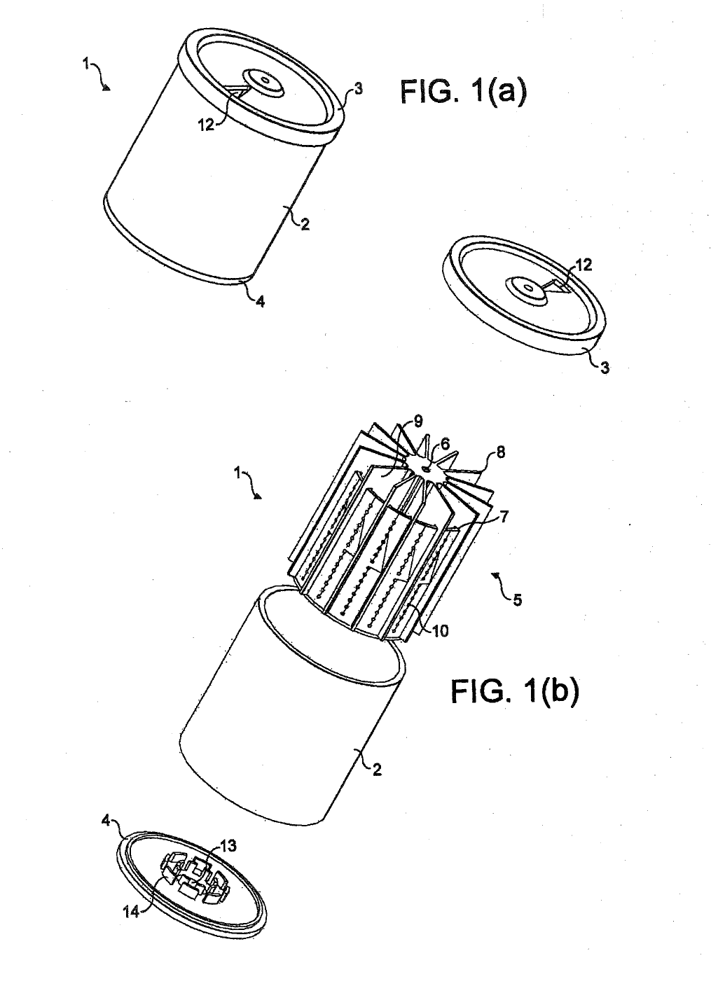

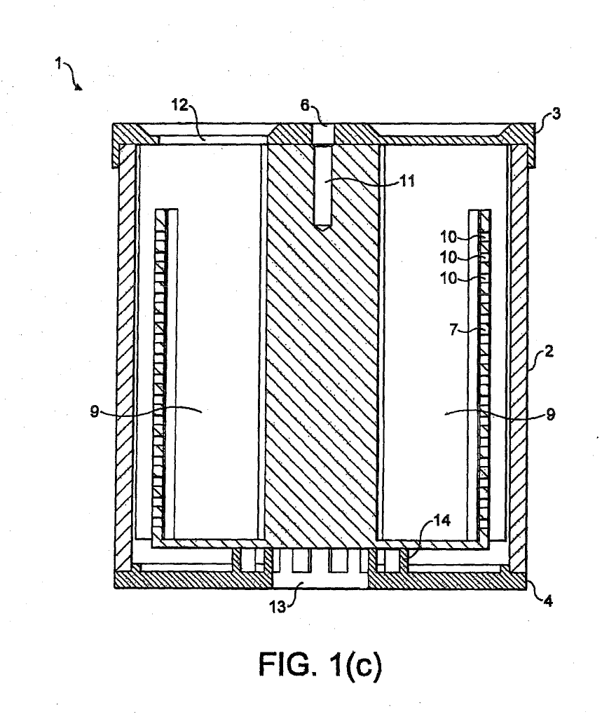

FIGS. 1(a), 1(b) and 1(c) are perspective, exploded perspective and cross-sectional side views of an embodiment of a detergent dispensing device included for background interest only;

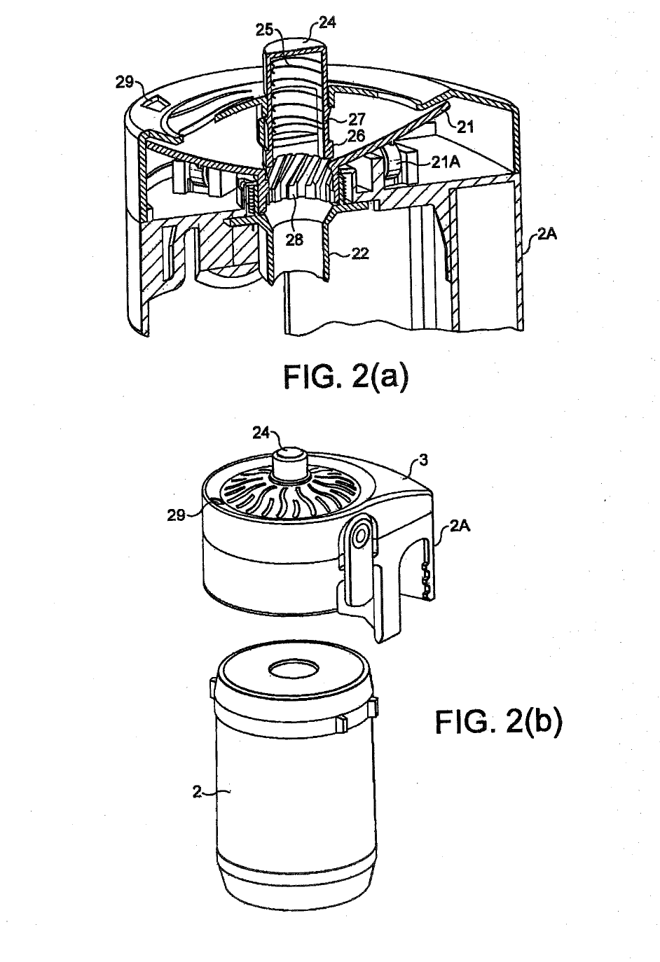

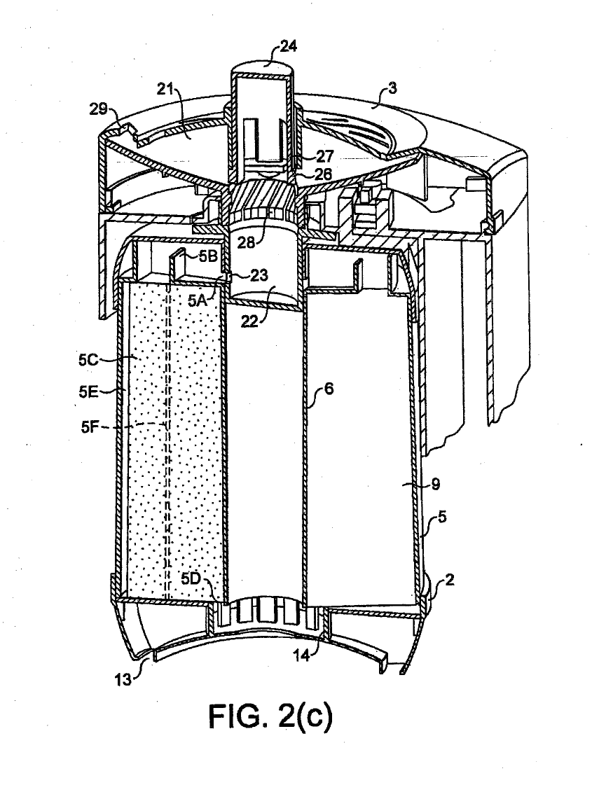

FIGS. 2(a) to 2(c) are perspective and cross-sectional perspective views of a first embodiment of a detergent dispensing device in accordance with the present invention;

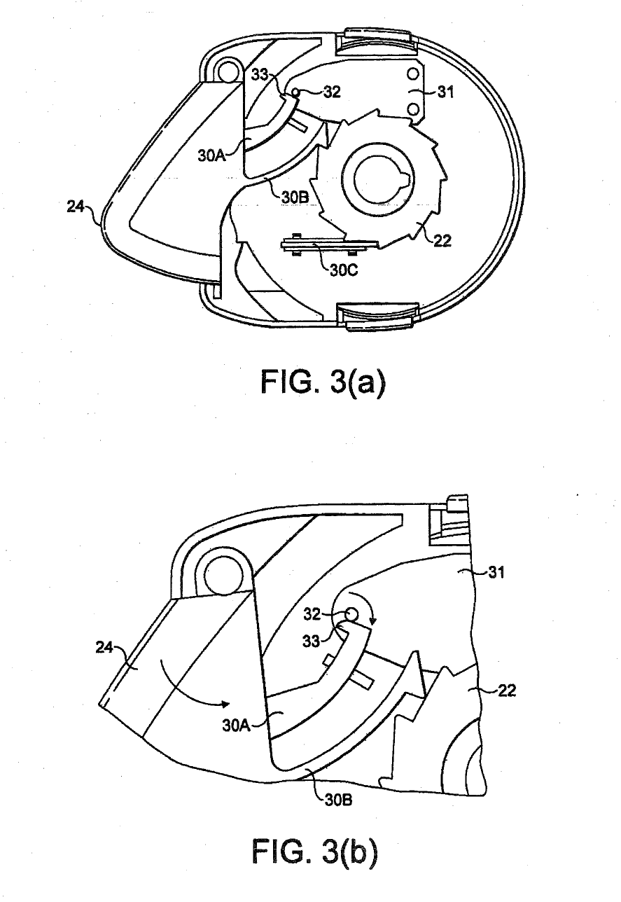

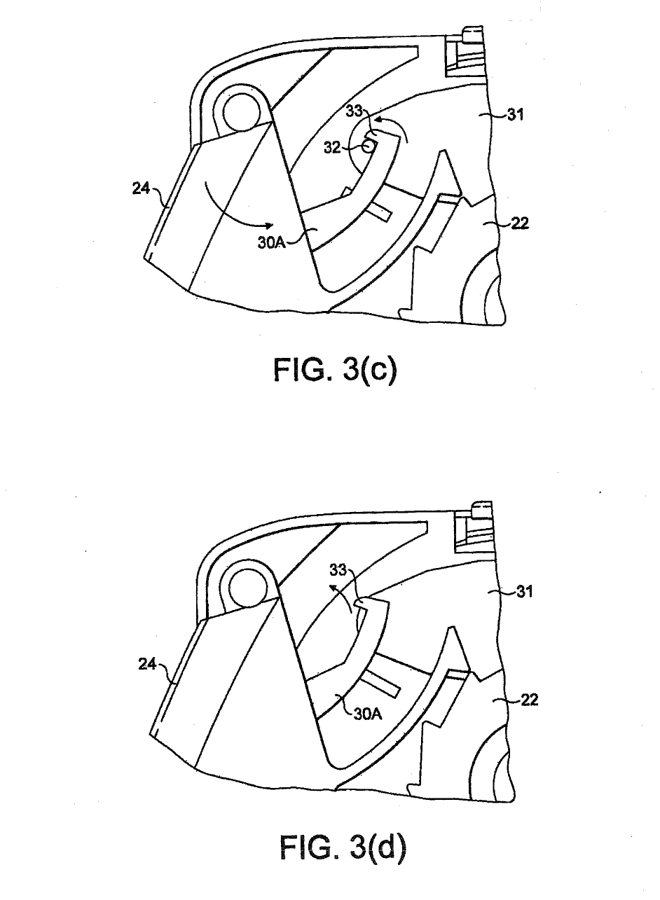

FIGS. 3(a) to 3(d) are perspective and cross-sectional perspective views of a second embodiment of a detergent dispensing device in accordance with the present invention;

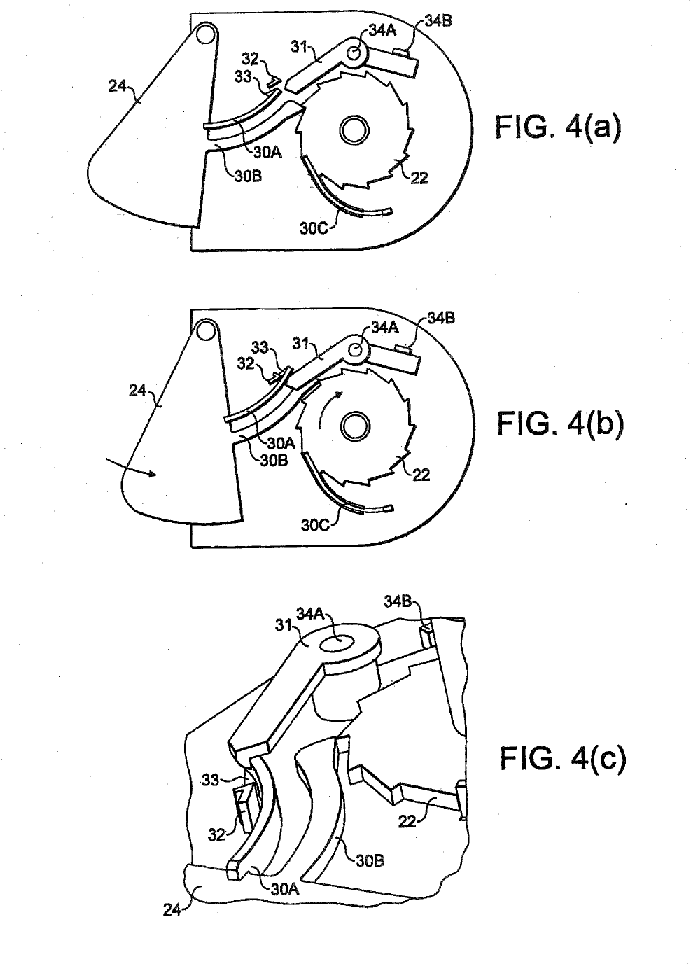

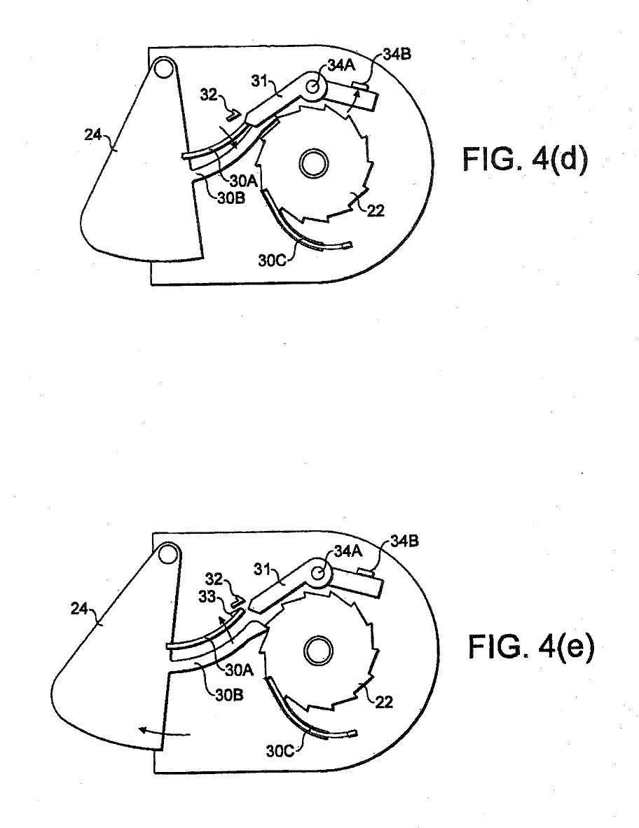

FIGS. 4(a) to 4(e) are perspective and cross-sectional perspective views of a third embodiment of a detergent dispensing device in accordance with the present invention;

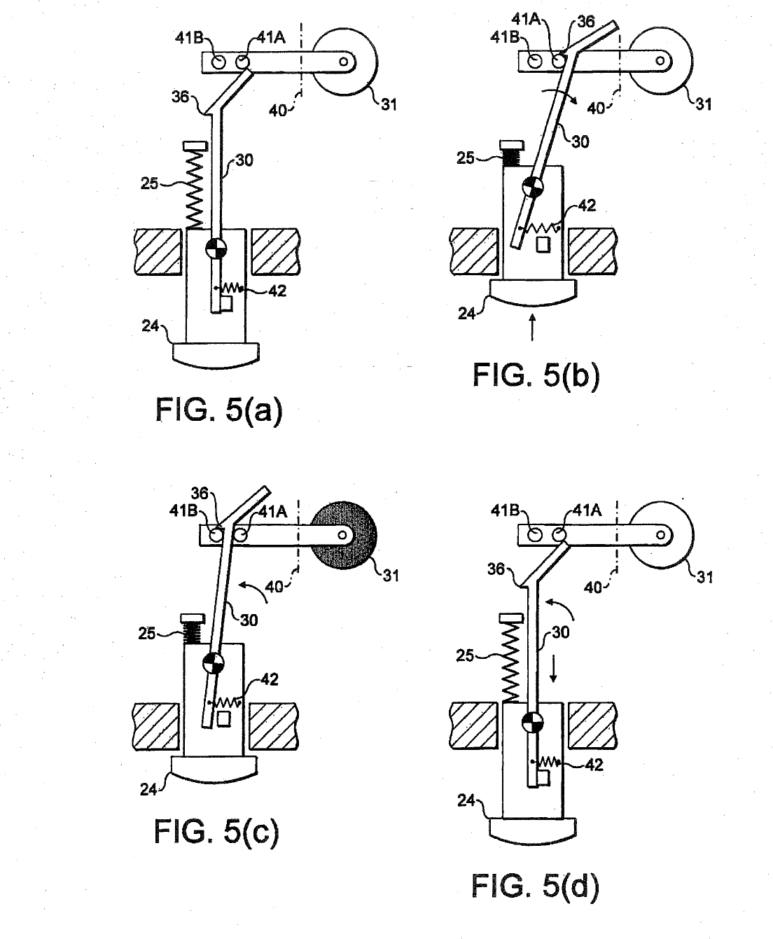

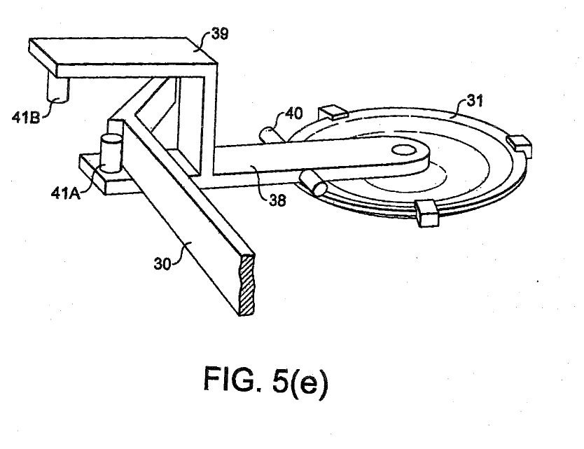

FIGS. 5(a) to 5(e) are perspective and cross-sectional perspective views of a fourth embodiment of a detergent dispensing device in accordance with the present invention;

The device of the present invention may be a free standing device removably insertable into a dishwasher, or may be built into the dishwasher e.g. in the door.

FIGS. 1(a) to 1(c) show a detergent dispensing device 1 included for background interest only. The device 1 comprises a housing 2 which is in the form of a cylinder having a lid 3 and a base 4.

Disposed within the housing 2 is a cartridge 5. The cartridge 5 is also based on a cylinder. The cartridge 5 has a central hub 6 and an outer periphery 7. Arranged at regular intervals are a plurality of limbs 8 which extend from the hub 6 to the periphery 7. The limbs 8 serve as to divide the centre of the cartridge 5 into a plurality of wedge shape chambers 9. The limbs 8 extend up to lid 3 so as to separate the chambers from one another. In the diagram as shown there are fourteen chambers 9 clearly it will be appreciated that the number of changes may be different from that shown.

The chambers are intended to be filled with a detergent composition (not shown).

The periphery 7 of each chamber 9 has a plurality of drainage apertures 10.

The lid 3 is rotatable relative to the remainder of the housing 2 and the cartridge 5. The lid 3 has a spindle 11 which co-operates with the hub 6 of the cartridge 5. The lid incorporates a inlet aperture 12, which serves, in use, as to direct wash liquor into a particular chamber of the cartridge 5.

In use the lid is arranged such that the inlet aperture 12 is arranged adjacent to an appropriate chamber 9. This may be done entirely manually or by the use of an automatic component as described in later examples. This entirely manual operation is not in accordance with the present invention. The device 1 may then be inserted into an automatic washing machine (such as an automatic dishwasher). In use the wash liquor is directed through the inlet aperture 12 into an adjacent chamber 9. The incoming wash liquor contacts any detergent present within the chamber 9 and washes the detergent out of the chamber 9 through one of the drainage apertures 10. The thus loaded wash liquor flows through the space between the cartridge 5 and the housing 2 and leaves the housing 2 through a uni-directional dispense aperture 13, which is, in use, in the bottom of the housing.

As shown the uni-directional dispense aperture 13 achieves this function by an arrangement of baffles 14, these baffles 14 allow the detergent loaded liquor to be dispensed from the device 1 under the action of gravity. However any wash liquor entering the device 1 through aperture 13 is generally deflected back through aperture 13 by the baffles. The general downward flow through the device also serves to wash out any such unwanted flow. A clearance is provided between the bottom of the cartridge 5 and the base 4 so that the detergent in unselected chambers is held away from the liquid in the bottom of the housing (either unwanted backflow or flow through the selected chamber).

FIGS. 2(a) to 2(c) show a first embodiment of a detergent dispensing device 1 in accordance with the invention. Like the previous embodiment the housing 2 and the cartridge 5 are circular/cylindrical. The housing 2 has a clip 2A for attachment to a basket within the machine to maintain the device upright. The cartridge has a similar configuration to that of the previous example, with the differences being set out below. The main difference compared to the first example is that the manually rotatable lid 3 has been replaced by a more sophisticated mechanism.

The cartridge 5 is not rotatable relative to the lid 3. Instead to allow access of wash liquor to the chambers 9 the device comprises a collecting funnel 21 which co-operates with a rotatable directing spout 22.

In operation incoming wash liquor is collected in the funnel 21 and allowed to flow to the directing spout 22. The directing spout 22 has a spout outlet 23 which directs wash liquor to a single chamber 9. For successive wash cycles/successive operations both the funnel 21 and the directing spout 22 are rotated relative to the cartridge 5 so that a successive chamber 9 can be accessed.

To effect rotation of the funnel 21 a user depresses an operating button 24 against a bias spring 25. Upon depression of the operating button 24, lugs 26, on arms 27, dependent from the button 24 engage with slots 28 disposed within a central opening of the funnel 21. The button 24 is non-rotatably mounted in the lid 3 and since the slots 28 are inclined at an angle from the vertical axis of the hub 6, depression of the button 24 causes rotation of the funnel 21 (and the associated directing spout 22) within the housing 2 supported on bearing wheels 21A.

The rotation of the funnel 21 within the housing 2 is such that a successive chamber 9 of the cartridge 5 may be accessed by incoming wash liquor, (i.e. the slots 28, the lugs 26 and the arms 27 are arranged such that full depression of the operating button 24 causes rotation of the funnel 21 such that a successive chamber 9 is brought into an operational position).

To aid the user in knowing how many chambers of the cartridge 5 remain the lid 3 includes a window 29. Through the window 29 a user can view a portion of the funnel 21. The viewed portion preferably contains numerals associated with the number of the chamber 9 in use or number or chambers 9 remaining (i.e., chambers 9 which still contain detergent).

The bias spring 25 preferably comprises a bimetallic material. In use, when the button 24 is depressed before the wash cycle commences, the button 24 does not return to its original position. This non-return function aids the prevention of accidental multiple operation of the device 1. Towards the end of the wash cycle as the temperature increases in the rinse and/or drying cycle, the spring 25 is activated returning the button 24 to its original position.

When the button 24 returns to its original position, reverse rotation of the funnel 21 is prevented by two mechanisms. Firstly, a ratchet mechanism (not shown) prevents rotation. Secondly, preferably the arms 27 are resilient, such that on upward movement the arms bend inwards and do not engage the slots 28.

When the last chamber 9 of the cartridge 5 is placed in its operational position the directing spout 22 engages an ‘end-stop’ so that the funnel 21 cannot rotate any further.

In this position if the button 24 is operated the lugs 26 simply ride over the slots 28 by virtue of flexing of the arms 27.

When the last chamber 9 has been used the cartridge 5 can be replaced by a user.

As is apparent from FIG. 2c, the cartridge 5 is configured differently from that of FIG. 1. In particular, the inlet 5A to each chamber 9 is no longer at the end wall of the cartridge, but is instead at the top of a radially inwardly facing wall facing the hub 6 so as to be aligned with the spout 22. A weir 5B is provided between the inlet 5A and the detergent 5C to prevent small amounts of water which may be directed to an unselected chamber 9 when coming into contact with the detergent. In place of the axially spaced drainage apertures 10 is a single aperture 5D in the bottom face of the chamber. In order to assist the general flow of the wash liquor through the chamber 9, there is a space 5E between the radially outermost edge of the detergent 5C and the inner wall of cartridge 5. Further, one or more axially extending through holes 5f are provided in the detergent to facilitate flow.

Also, to provide a uni-directional flow out of the bottom of the device, the outlet 13 is now towards the outer periphery of the device and is radially offset by considerable amount in relation to the outlets 5D. Also, baffles 14 will direct any unwanted back flow through outlet 13.

FIGS. 3(a)-3(d) show a second embodiment of a detergent dispensing device 1. Like the first embodiment the housing 2 and the cartridge 5 are circular/cylindrical. This device has a similar spout and cartridge to that of the first embodiment. However, the manner in which the button is operated is different.

The device 1 has a directing spout 22 in the form of a ratchet (the directing spout 22 preferably co-operates with a collecting funnel 21 (not shown but as described in FIGS. 2a to 2c). The directing spout has a spout outlet. In operation incoming wash liquor is collected in the funnel and allowed to flow via the directing spout 22. For successive wash cycles/successive operations the directing spout 22 is rotated relative to the cartridge 5 so that a successive chamber 9 can be accessed.

The operation is explained with reference to a sequence of events from FIGS. 3(b) to 3(d). The button 24 is designed to be operated by engagement with a dishwasher door rather than the hand of an operator as in FIGS. 2a to 2d. This device will need to be positioned within the machine so that the door presses the button as it closes.

In FIG. 3(b) the dishwasher door is open and the dishwasher is cold. In this state the user can fill the dishwasher with houseware, opening and closing the dishwasher door as often as is necessary to fully load the dishwasher.

The first time that the dishwasher door is closed the operating button 24 is depressed (the button 24 is spring biased away from the device) and is retained in a depressed condition by virtue of a first arm 30A (see FIG. 3(c)).

A first arm 30A operates in conjunction with a bimetallic strip 31. The bimetallic strip 31 is in the form of a blade mounted on the lid 3. The bimetallic strip 31 has a rod 32 extending from its non-mounted end.

The first arm 30A terminates in a flange 33.

When the door is closed (thus moving the button 24 towards the device 1) the arm 30A is moved inward towards the bi-metallic strip 31. The flange 33 passes behind and engages the rod 32. This engagement locks the operating button 24 in position: further opening of the dishwasher door cannot cause movement of the button 24.

As shown in FIG. 3(d) the dishwasher operation has begun. As a result of the operation (elevated temperature) the bi-metallic strip 31 is altered to its high temperate state. This has the effect that the rod 32 moves away from the first arm 30A until it no longer engages flange 33.

As the flange 33 is no longer engaged by rod 32 the arm 30a moves sideways. The operating button 24 is now free to move once the dishwasher door is opened. Thus when the dishwasher door opens the button 24 is moved away from the device by a return spring (not shown).

A second arm 30B (attached to the button 24), in the form of a lever pawl engages the directing spout 22. Outward movement of the button 24, and attached arm 30B caused further movement of the directing spout 22. In this way the orientation of the directing spout 22 is altered such that a new chamber 9 of the cartridge 5 is put in to an operational position for the next dishwasher cycle.

If the dishwasher is not open for some time (and thus cools down) re-engagement of the rod 32 and the flange 33 (potentially caused by the movement of the bimetallic strip 31 back to its low temperature configuration) is prevented by the movement of the arm 30A past the rod 32.

A third arm 30C provides a biasing force against the spout 22 to prevent reverse rotation of the spout when the second arm 30B is disengaged from the spout.

When all the chambers 9 of the cartridge 5 have been used further movement of the directing spout 22 (and hence the cartridge 5) is prevented by engagement of a lug (not shown) on the directing spout 22 with a pawl (not shown).

FIGS. 4(a) to 4(e) show a third embodiment of a detergent dispensing device 1.

The third embodiment is very similar to the second embodiment. Only the material differences will be described in detail. Again, the detergent cartridge is as described previously.

The main differences are the operation of the arms 30A and 30B and the operation of the bimetallic strip 31.

The operation is explained with reference to a sequence of events from FIGS. 4(a) to 4(e).

In FIG. 4(a) the dishwasher is cold and the dishwasher door is open.

In FIG. 4(b) the dishwasher door is closed. The arm 30B engages the directing spout 22 and rotates the directing spout 22, bringing a new chamber 9 of the cartridge 5 into an operating position.

Also shown in FIG. 4(b) a flange 33 on arm 30A engages a rod 32 in the lid 3. This engagement of the flange 33 with the rod 32 prevents further movement of the button 24, in the event that the dishwasher door is opened, e.g., during the wash cycle.

The device 1 comprises a bimetallic strip 31 in the form of a bent rod, the rod being looped around and mounted around a first mounting 34a and abutting against a second mounting 34b.

During the wash cycle as the temperature in the machine increases the bimetallic strip 31 changes to its high temperature configuration passing arm 30A and dropping down behind it to engage the flange 33 (FIGS. 4(c) and 4(d)).

As the machine cools after the wash cycle the bimetallic strip 31 returns to its low temperature configuration. In doing so it disengages the flange 33 from the rod 32 (FIG. 4(e)). With the disengagement the button 24 is free to move away from the device 1. Thus the arm 30B is moved relative to the directing spout 22 such that the device 1 is ready for the next operation.

FIGS. 5(a)-5(e) show a variant of a thermal control arrangement that can be used with a device of the present invention.

The arrangement comprises an operating button 24 (which can be manually operated or door operated) linked to an arm 30. The arm 30 may operate an element of the device 1 or may simply provide a restriction on the operation of the button 24. The arm has a heel 36.

A bimetallic element 31 (here in the form of a snap disc) has a frame 37 associated therewith.

The frame 37 comprises an arm 38 and a jaw 39.

The frame arm 38 is connected to the centre of the snap disc 31. Along a portion of the frame arm 38 is disposed a pivot 40. At the other end of the frame arm 38 is the jaw 39.

The jaw 39 is disposed around the heel portion 36 of the arm 30. The jaw 39 has a lower tooth 41A and an upper tooth 41B which are intended to interact with the heel 36. The upper tooth 41B is disposed further from the pivot 40 than the lower tooth 41A.

In use the button 24 is depressed against a spring bias 25. This causes movement of the arm 30 relative to the jaw 39 such that the heel 36 engages at the lower tooth 41A (against a spring bias 42). As a result of this engagement the button 24 is retained in its activated position regardless of whether the dishwasher door is opened and/or a user attempts further activation.

As the dishwasher machine operates the temperature of the dishwasher and hence the overall device 1 increases. With this temperature increased the snap disc 31 alters to its high temperature configuration. This alteration raises the section of the frame arm 38 which is connected to the snap disc 31. The other end of the frame arm 38 is lowered (pivoting about axis 40) and thus the jaw 39 is lowered. This has the effect that the engagement of the heel 36 with a lower tooth 41A is severed. The heel 36 then engages the upper tooth 41B, the heel being pushed towards the upper tooth 41B by the spring bias 42.

As the dishwasher cycle is completed and the dishwasher cools (possibly aided by opening of the dishwasher door) the snap disc 31 reverts to its lower temperature configuration. This has the effect that the upper tooth 41B is raised away from the heel 36 until the heel 36—upper tooth 41B engagement is broken.

Since the heel 36 encounters no further retaining force the spring bias working against the button 24 is able to push the button 24 back to its inactivated position.

1. A detergent dispensing device adapted for use in an automatic washing machine, the device having a plurality of chambers to accommodate a detergent composition, a selecting means to selectively expose each chamber to wash liquor allowing the detergent, in use, to be washed out of the chamber; a manual operating means being movable from a first position to a second position for loading mechanical energy into the device which provides a restoring force for the operating means, and a return motion prevention means to retain the operating means in the second position, the return motion prevention means being arranged to move when subjected to a condition prevailing in an interior of the machine during a wash cycle, thereby moving the operating means to the first position or releasing the operating means to return to the first position during a single wash cycle; the operating means being arranged to move the selecting means and cartridge relatively to one another to advance the selecting means to an adjacent chamber as it moves either from the first to the second position, the second to the first position, or both.

2. A device according to claim 1, wherein the operating means is arranged to advance the selecting means to an adjacent chamber as it moves from the second to the first position.

3. A device according to claim 1, wherein the operating means is arranged to advance the selecting means to an adjacent chamber as it moves from the first to the second position.

4. A device according to claim 1, wherein the return motion prevention means is a thermal element arranged to be moved when subjected to a predetermined temperature.

5. A device according to claim 1, wherein the return motion prevention means is a latch which selectively obstructs return motion of the operating means.

6. A device according to claim 1, wherein the return motion prevention means is a thermally expandable element which is moved on operation of the operating means, but will not return to its original position until subjected to an elevated temperature when it expands to move the operating means.

7. A device according to claim 1, wherein the selecting means has an opening which is selectively alignable with each chamber.

8. A device according to claim 7, wherein the selecting means comprises a spout which is rotatable into alignment with an opening to a respective chamber.

9. A device according to claim 8, wherein the spout is arranged to block access of the wash liquor to unselected chambers.

10. A device according to claim 1, wherein the device is provided with a funnel leading to the selecting means.

11. A device according to claim 1, wherein the selecting means is configured to be operated by the hand of a user.

12. A device according to claim 1, wherein the selecting means is configured to be operated by the door of the machine.

13. (canceled)

14. A detergent dispensing device adapted for use in an automatic washing machine, the device having a plurality of chambers to accommodate a detergent composition, a selecting means configured to be manually operated by the hand of a user to selectively expose each chamber to wash liquor allowing the detergent, in use, to be washed out of the chamber; a manual operating means being movable from a first position to a second position for loading mechanical energy into the device which provides a restoring force for the operating means, and a return motion prevention means to retain the operating means in the second position, the return motion prevention means being arranged to move when subjected to a condition prevailing in an interior of the machine during a wash cycle, thereby moving the operating means to the first position or releasing the operating means to return to the first position during a single wash cycle; the operating means being arranged to move the selecting means and cartridge relatively to one another to advance the selecting means to an adjacent chamber as it moves either from the first to the second position, the second to the first position, or both.

15. A detergent dispensing device adapted for use in an automatic washing machine, the device having a plurality of chambers to accommodate a detergent composition, a selecting means configured to be operated by door of the machine to selectively expose each chamber to wash liquor allowing the detergent, in use, to be washed out of the chamber; a manual operating means being movable from a first position to a second position for loading mechanical energy into the device which provides a restoring force for the operating means, and a return motion prevention means to retain the operating means in the second position, the return motion prevention means being arranged to move when subjected to a condition prevailing in an interior of the machine during a wash cycle, thereby moving the operating means to the first position or releasing the operating means to return to the first position during a single wash cycle; the operating means being arranged to move the selecting means and cartridge relatively to one another to advance the selecting means to an adjacent chamber as it moves either from the first to the second position, the second to the first position, or both.
